(19) United States
(12) Patent Application Publication
(10) Pub. No.: US 2016/0156733 A1
(43) Pub. Date: Jun. 2, 2016

(54) CONTENT PLACEMENT IN HIERARCHICAL NETWORKS OF CACHES

(71) Applicant: Fujitsu Limited, Kawasaki-shi (JP)

(72) Inventors: Golnaz FARHADI, Sunnyvale, CA (US); Bita AZIMDOOST, Los Gatos, CA (US)

(21) Appl. No.: 14/557,280

(22) Filed: Dec. 1, 2014

(51) Int. Cl. H04L 29/08

(52) U.S. Cl. CPC H04L 67/2852; H04L 67/1097

(57) ABSTRACT

According to an aspect of an implementation, a method includes decomposing an optimization problem in a network that includes three or more levels into two or more two-tier optimization problems. The method also includes passing a storage value and one or more cost values obtained from an upper or lower one of the two-tier optimization problems into, respectively, a lower or upper one of the two-tier optimization problems.

### FIELD

The implementations discussed herein are related to content placement in hierarchical networks of caches.

### BACKGROUND

Unless otherwise indicated herein, the materials described herein are not prior art to the claims in the present application and are not admitted to be prior art by inclusion in this section.

While present Internet structures are host-oriented and configured based on a one-to-one paradigm, a majority of current Internet uses, such as viewing and sharing videos, music, photographs, documents, and more, may have a data or content centric aspect different from a host centric aspect. Information centric networks (ICNs), in which endpoints communicate based on named data instead of Internet Protocol (IP) addresses, have evolved as an alternative to the host-oriented Internet architecture. ICNs seek to provide scalable and cost-efficient content distribution.

The subject matter claimed herein is not limited to implementations that solve any disadvantages or that operate only in environments such as those described above. Rather, this background is only provided to illustrate one example technology area where some implementations described herein may be practiced.

### SUMMARY

According to an aspect of an implementation, a method includes decomposing an optimization problem in a network that includes three or more levels into two or more two-tier optimization problems. The method also includes passing a storage value and one or more cost values obtained from an upper or lower one of the two-tier optimization problems into, respectively, a lower or upper one of the two-tier optimizations.

The object and advantages of the embodiments will be realized and achieved at least by the elements, features, and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

Example implementations will be described and explained with additional specificity and detail through the use of the accompanying drawings in which:

FIG. 1A is a schematic diagram illustrating an example ICN;

FIG. 1B is a schematic diagram illustrating the example ICN of FIG. 1A including one or more super leaves;

FIG. 1C is a schematic diagram illustrating the example ICN of FIG. 1A including one or more super parents;

FIG. 2A is a schematic diagram of three example data structures of a typical ICN router;

FIG. 2B is a schematic diagram of an example solution table and access history table at a first root node;

FIG. 3 is a block diagram illustrating an example ICN router system;

FIG. 4 is an example flow diagram illustrating a content placement and storage allocation method in a top-down algorithm; and

FIG. 5 is an example flow diagram illustrating a content placement and storage allocation method in a bottom-up algorithm.

### DESCRIPTION OF IMPLEMENTATIONS

The demand for streaming video and audio on the Internet has grown in recent years, increasing Internet traffic. Information Centric Networks (ICNs) and other hierarchical networks of caches provide an architecture for in-network caching to enhance content delivery. An ICN may include one or more sub-networks, in which routers may be connected to one another to share content. Each router of the ICN may also have storage space to store requested content. In an ICN, when the total storage and link capacities are limited, optimization of both the location at which content is stored and the storage size allocation at each router may reduce the overall cost of data delivery for the ICN. Accordingly, some implementations described herein relate to an architecture for a hierarchical network of caches, such as, e.g., an ICN, and supporting communication protocols capable of reducing the total cost of data delivery to the network or content provider through optimization. “Optimization” as referred to herein may include maximizing or minimizing a real function, where “maximizing” or “minimizing” does not necessarily mean achieving an absolute maximum or minimum but a relative maximum or minimum as compared with other values.

In some implementations described herein, a linear program optimization problem (LPOP) may be decomposed into two or more two-tier LPOPs according to a top-down or bottom-up algorithm. A storage value and one or more cost values may be passed from an upper or lower two-tier LPOP into, respectively, a lower or upper two-tier LPOP. Each LPOP may include a parameter based on a popularity of each requested content at each node in the network or a popularity of each requested content listed in a content catalog. The two or more LPOPs may be executed or solved to determine content placement and storage size allocation for one or more nodes in the network. Further, where the network includes two or more sub-networks, the top-down algorithm may be used in one sub-network, while the bottom-up algorithm may be used in another sub-network, depending on a similarity of demand statistics among nodes in the sub-networks.

Implementations of the present invention will be explained with reference to the accompanying drawings.

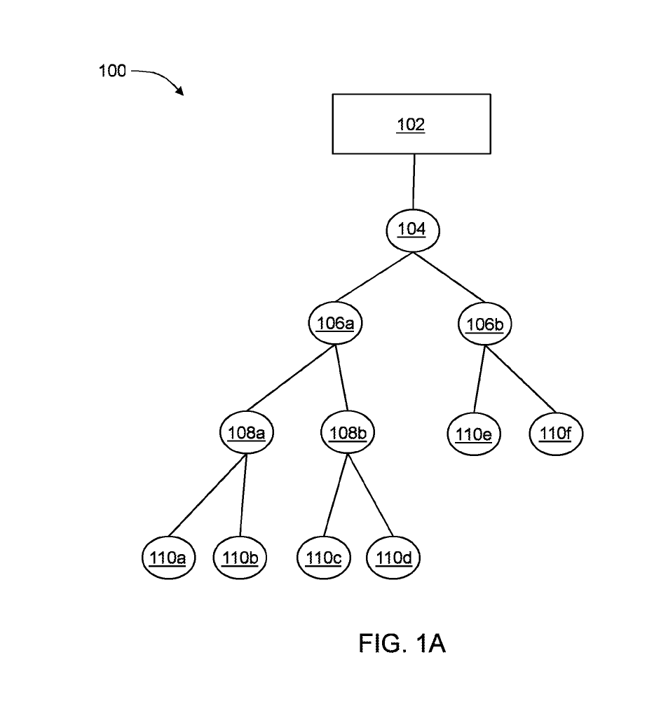

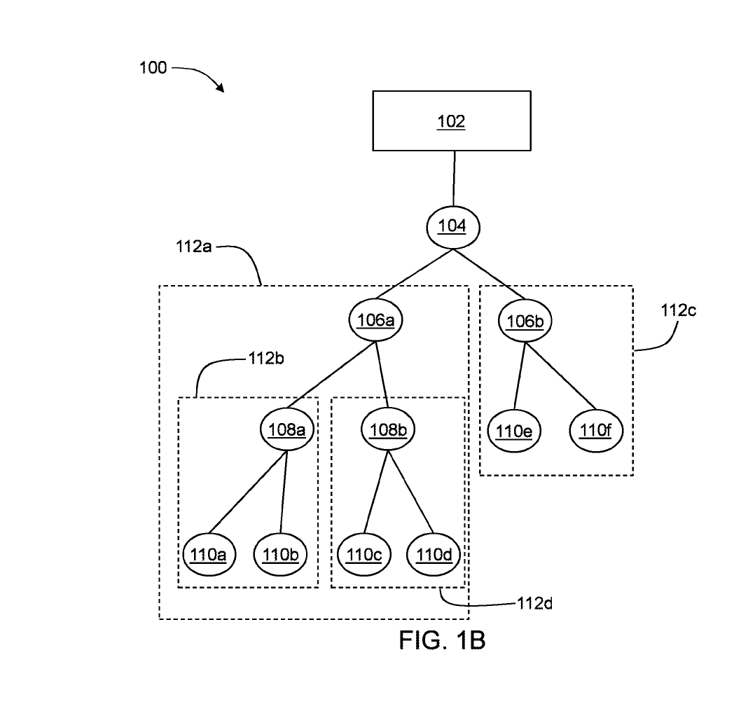

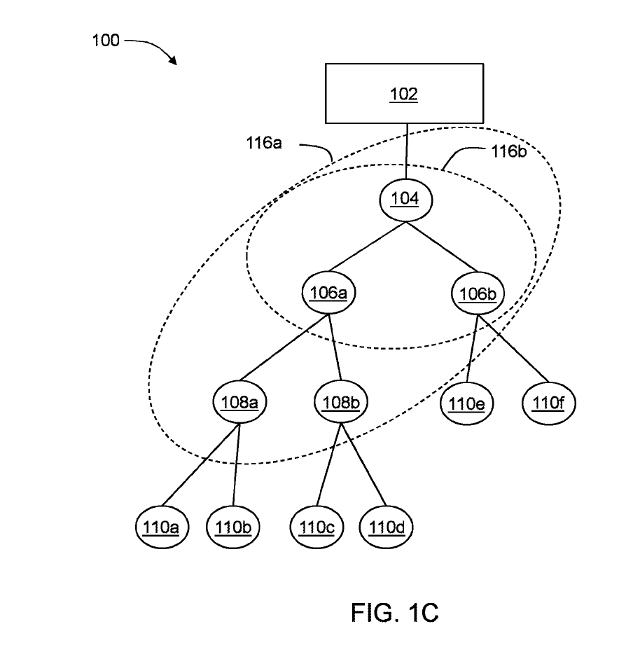

FIG. 1A is a schematic diagram illustrating an example ICN, arranged in accordance with at least one implementation described herein. The ICN 100 may include a network of nodes configured to route messages, which may also be referred to as “interest packets,” and to deliver data packets. The term “interest packet” may refer to a request for some content. The term “data packet” may refer to the content that satisfies the interest packet. Each interest packet may correspond to one data packet.

In various implementations, the ICN 100 may include or may be included in the Internet or a portion thereof. As illustrated in FIG. 1A, the ICN 100 may include a server 102 and a number of network nodes, including a first root node 104, two second root nodes 106a, 106b (generically “second root node 106” or “second root nodes 106”), two third root nodes 108a, 108b (generically “third root node 108” or “third root nodes 108”), and six edge nodes 110a-110f (generically “edge node 110” or “edge nodes 110”).

It will be appreciated, with the benefit of the present disclosure, that the ICN 100 illustrated in FIG. 1A may constitute, in some respects, a simplification. For example, the ICN 100 may include different numbers of the first root nodes 104, second root nodes 106, third root nodes 108, and/or edge nodes 110 than are illustrated in FIG. 1A. The ICN 100 may include upstream nodes between the first root node 104 and the server 102. The ICN 100 may include intermediate nodes and/or additional root nodes between the first root node 104 and the second root nodes 106, the second root nodes 106 and the third root nodes 108, and/or the edge nodes 110. Further, each of the first root node 104, second root nodes 106, third root nodes 108, and/or edge nodes 110 may include one or more intermediate nodes and/or additional root nodes. The ICN 100 may include numerous additional network nodes, such as clients, servers, routers, switches, and/or other network devices.

The network topology of the ICN 100 may include a hierarchical structure. The network topology may include a tree structure or set of tree structures. In the hierarchical tree structure topology shown in FIG. 1A, the second root nodes 106 may interconnect the first root node 104 and the third root nodes 108, such that interest packets and data packets may be exchanged between these nodes. The third root nodes 108 may interconnect the second root nodes 106 and the edge nodes 110, such that interest and data packets may be exchanged between these nodes. Similarly, the first root node 104 may interconnect the server 102 and the second root nodes 106, such that interest and data packets may be exchanged between these nodes. The edge nodes 110a-110d may be considered to be downstream from the third root nodes 108, which may be considered to be downstream from the second root node 106a, which may be considered to be downstream from the first root node 104, which may be considered to be downstream from the server 102. Similarly, the edge nodes 110e-110f may be considered to be downstream from the second root node 106b, which may be considered to be downstream from the first root node 104, which may be considered to be downstream from the server 102.

The network topology of the ICN 100 may include three or more levels. The level of a node in the ICN 100 may be determined by the number of hops between the node and the first root node 104, or between the node and the server 102, or between the node and some other reference point. The second root nodes 106 may be considered to be on the same level of the ICN 100, and the four edge nodes 110a-110d may be considered to be on the same level of the ICN 100. The third root nodes 108 may be considered to be on the same level of the ICN 100 as the edge nodes 110e-110f.

Each of the first root node 104, second root nodes 106, third root nodes 108, and edge nodes 110 of the network may include a router. The term “router” may refer to any network device capable of receiving and forwarding interest packets and/or receiving and forwarding data packets. The term “server” may refer to any device capable of receiving interest packets and serving data packets. The first root node 104, second root nodes 106, third root nodes 108, edge nodes 110, and server 102 may host a content, or more generally one or more different contents, each content being identified by at least one content name.

Each of the edge nodes 110 may include or may be coupled to a client device, such as a desktop computer, a laptop computer, a tablet computer, a mobile phone, a smartphone, a personal digital assistant (PDA), a wearable device, or other client device.

A node that is downstream from the first root node 104 in the ICN 100 and from which an interest packet for a content originates is referred to herein as a “request node.” Any of the edge nodes 110 may be referred to as a request node when it is the node from which an interest packet originates. When an interest packet originates from a request node 110, the interest packet may then be routed to the first root node 104 and may be received by the first root node 104, even if the interest packet has already been satisfied by delivery of the corresponding data packet from a node in the ICN 100 downstream from the first root node 104 and on the path to the first root node 104, such as, for example, the second root node 106 or third root node 108. The interest packet may identify the requested content name as well as the request node 110 and any nodes that forward the interest packet to the first root node 104, such as, for example, the second root node 106 and/or the third root node 108. The first root node 104 may thus act as a data collector for the ICN 100, keeping track of how many times a content has been requested by each node in the ICN 100 in an access history table. The first root node 104 may use the access history table to determine the popularity of the content at each node in the ICN 100. In some embodiments, a node in the ICN 100, including the second root node 106 and/or the third root node 108, may keep track of how many times a content has been requested by nodes downstream to the node in an access history table of a corresponding one of the second root node 106 and/or the third root node 108.

The first root node 104 may decompose a LPOP in the network into two or more two-tier LPOPs. The objective of each two-tier LPOP may be to minimize total data download cost in the ICN 100. Each two-tier LPOP may be useful when total storage capacity and link capacities are limited, and may include one or more constraints designed to avoid congestion on the downlinks between the first root node 104 and the request node 110. Each two-tier LPOP may be executed using the Interior Point or Simplex method. Example implementations of two-tier LPOPs are disclosed in U.S. patent application Ser. No. ______, entitled CONTENT PLACEMENT IN AN INFORMATION CENTRIC NETWORK and filed concurrently herewith. The foregoing application is herein incorporated by reference.

The first root node 104 may decompose a LPOP in the network into two or more two-tier LPOPs according to a top-down algorithm or a bottom-up algorithm. In some embodiments, the network may include two or more sub-networks, wherein each sub-network has its own first root node 104. Decomposing a LPOP in the network into two or more two-tier optimization problems may be performed according to a top-down algorithm in a first sub-network and according to a bottom-up algorithm in a second sub-network. The first root node 104 may determine whether to use the top-down algorithm or the bottom-up algorithm in one of the sub-networks based on a similarity of a demand statistic at each of the nodes on one or more levels of the sub-network and/or based on one or more other criteria.

FIG. 1B is a schematic diagram illustrating the example ICN of FIG. 1A including one or more super leaves 112a-112d (generically “super leaf 112” or “super leaves 112”), arranged in accordance with at least one implementation described herein. In the top-down algorithm, a first tier of a two-tier LPOP may include a root node and a second tier of the two-tier LPOP may include a super leaf 112. Each super leaf 112 may include the request node 110. The super leaf 112 of one two-tier LPOP may differ in size and number of levels nodes from the super leaf 112 of another two-tier LPOP. The super leaf 112 may include a plurality of nodes forming a tree with the first root node 104 as their ancestor.

The super leaf 112a, for example, may include the second root node 106a, the edge nodes 110a-110d, and any nodes in between the second root node 106a and the edge nodes 110a-110d, such as the third root nodes 108. The super leaf 112b may include the third root node 108a and the edge nodes 110a-110b. The super leaf 112c may include the second root node 106b and the edge nodes 110e-110f. The super leaf 112d may include the third root node 108b and the edge nodes 110c and 110d. The super leaf 112a includes nodes from three levels of the ICN 100, while the super leaves 112b-112d include nodes from two levels of the ICN 100. More generally, each of the super leaves 112 may include nodes from two or more levels of the ICN 100.

In the case of the top-down algorithm, the first tier of each two-tier LPOP may include a node from one level of the ICN 100. In these and other implementations, the first tier of a lower two-tier LPOP may be located on a lower level of the ICN 100 than the first tier of an upper two-tier LPOP. For example, while the first tier of an upper two-tier LPOP may include the first root node 104, the first tier of a lower two-tier LPOP may include the second root node 106.

The first root node 104 may receive an interest packet that originated, for example, from the request node 110a. The interest packet may identify a content and the request node 110a, as well as any nodes that forwarded the interest packet to the first root node 104, such as, e.g., the third root node 108a and the second root node 106a. The first root node 104 may update an access history table of the first root node 104 according to the received interest packet. The first root node 104 may execute an upper two-tier LPOP. The upper two-tier LPOP may include a parameter based on the popularity of each content of the ICN 100 at each node in the ICN 100.

Where the first tier of the upper two-tier LPOP includes, e.g., the first root node 104, and the second tier of the upper two-tier LPOP includes the super leaf 112a and the super leaf 112c, the parameters of the upper two-tier LPOP may also include a cost to obtain the content from the server 102, a cost to obtain the content from the first root node 104, and a cost to obtain the content from the super leaf 112a and/or the super leaf 112c. The upper two-tier LPOP may further include a total storage constraint value, indicating the combined storage limit for the first root node 104 and the super leaves 112a and 112c. A solution to the upper two-tier LPOP may include storage size allocation for the first root node 104 and a probability at which to store the content in the first root node 104, as well as a storage size allocation for each of the super leaf 112a and the super leaf 112c. Any content placement solution for the super leaf 112a or the super leaf 112c obtained from the upper two-tier LPOP may be ignored.

In a top-down, centralized algorithm, the first root node 104 may execute one or more lower two-tier LPOPs. The lower two-tier LPOPs may include a parameter based on the popularity of each content of the ICN 100 at each node in the ICN 100. The lower two-tier LPOPs may further include a total storage constraint value. Where the first tier of the lower two-tier LPOP includes, e.g., the second root node 106a, and the second tier of the lower two-tier LPOP includes the super leaf 112b and the super leaf 112d, the total storage constraint value may indicate a storage limit for the second root node 106, the super leaf 112b, and the super leaf 112d combined. The storage size allocation for the super leaf 112a obtained from the upper two-tier LPOP may be passed into the lower two-tier LPOP as the total storage constraint value. The parameters for the lower two-tier LPOP may also include a cost to obtain the content from the super leaf 112b, a cost to obtain the content from the super leaf 112d, a cost to obtain the content from the second root node 106a, and a cost to obtain the content from outside the super leaf 112a, which may be based on a cost to obtain the content from the server 102 and the first node 104. The cost to obtain the content from the first root node 104 and the server 102 obtained from the upper two-tier LPOP may be passed into the lower two-tier LPOP as the cost to obtain the content from outside the super leaf 112a.

Where two or more nodes are located inside the super leaf 112 on a delivery path of the content, the cost to obtain the content from the super leaf 112 may be determined by averaging the costs to obtain the content from each of the two or more nodes. For example, the cost to obtain the content from request node 110a and the cost to obtain the content from the third root node 108a may be averaged to determine the cost to obtain the content from the super leaf 112b.

Where two or more nodes are located outside the super leaf 112 in the ICN 100 on a delivery path of the content, the cost to obtain the content from outside the super leaf 112 may be determined by averaging the costs to obtain the content from each of the two or more nodes. For example, the cost to obtain the content from outside the super leaf 112a may be determined by averaging the cost to obtain the content from the server 102 and the cost to obtain the content from the first root node 104. Both the cost to obtain the content from the server 102 and the cost to obtain the content from the first root node 104 may be passed into the lower two-tier LPOP.

The solution to the lower two-tier LPOP may include storage size allocation for the second root node 106a and a probability at which to set a cache flag in a data packet of the content to indicate to the second root node 106a to store the content. The solution to the lower two-tier LPOP may also include the storage size allocation for the super leaf 112b and the storage size allocation for the super leaf 112d. Any content placement solution for the super leaf 112b or for the super leaf 112d obtained from the lower two-tier LPOP may be ignored.

In the top-down, decentralized algorithm, instead of the first node 104 executing the lower two-tier LPOP, the first node 104 may forward the storage and the one or more cost values obtained from the upper two-tier LPOP to another root node in the ICN 100 to allow the root node to solve the lower two-tier optimization to which the storage and cost values are passed. The root node may be downstream from the first root node 104. The root node may keep track of how many times a content has been requested by nodes downstream to the node in an access history table of the root node in order to execute an LPOP based on the popularity of each content of the network at each of the nodes downstream to the root node.

In both the centralized and decentralized top-down algorithms, when the lower two-tier LPOP includes a super leaf 112, where the super leaf 112 includes two or more levels, the lower two-tier LPOP may become an upper two-tier LPOP, passing a total storage constraint value and one or more cost values into another lower two-tier LPOP. The storage value may include a total storage constraint value and one of the cost values may include a cost of obtaining the content from outside of a super leaf of the other lower two-tier LPOP. The first node 104 may decompose the optimization problem in the ICN 100 into two-tier LPOPs with increasingly smaller super leaves 112 by moving a root node of a first tier of a two-tier LPOP to a lower level of the ICN 100 than a root node of the first tier of a previously executed two-tier LPOP. A storage value and one or more cost values obtained from the previously executed two-tier LPOP may be passed into a lower two-tier LPOP with a smaller super leaf 112.

The second tier of a two-tier LPOP may include only one or more edge nodes 110. In response to the second tier of the two-tier LPOP including only one or more edge nodes 110, the first root node 104 may solve the two-tier LPOP to obtain storage size allocation for the one or more edge nodes 110 and the root node of the two-tier LPOP, as well as a probability at which to set a cache flag in a data packet of the content to indicate to the one or more edge nodes 110 and the root node to store the content.

FIG. 1C is a schematic diagram illustrating the example ICN of FIG. 1A including one or more super parents, arranged in accordance with at least one implementation described herein. In the bottom-up algorithm, a first tier of a two-tier LPOP may include a super parent 116a-116b (generically “super parent 116” or “super parents 116”), and a second tier of the two-tier LPOP may include one level of nodes of the ICN 100 below the super parent 116. For example, the first tier of the two-tier LPOP may include the super parent 116a, and the second tier of the two-tier LPOP may include the edge nodes 110a-110d. Each super parent 116 may include the first root node 104. The super parent 116 of one two-tier LPOP may differ in size and number of levels from the super parent 116 of another two-tier LPOP. The super parent 116 may include a plurality of nodes forming a tree. The super parent 116a may include three levels of the ICN 100, including the first root node 104, the second root nodes 106, and the third root nodes 108, while the super parent 116b may include only two levels of the ICN 100, as shown in FIG. 1, including the first root node 104 and the second root nodes 106. One of the edge nodes 110e-110f may be a request node.

The second tier of a lower two-tier LPOP may be located on a lower level of the ICN 100 than the second tier of an upper two-tier LPOP. For example, while the second tier of a lower two-tier LPOP may include the edge nodes 110a-110f, the second tier of an upper two-tier LPOP may include the third root nodes 108a-108b, located a level higher than the edge nodes 110a-110d.

The first root node 104 may receive an interest packet that originated, for example, from the request node 110a. The interest packet may identify a content and the request node 110a, as well as any nodes that forwarded the interest packet to the first root node 104, such as, e.g., the third root node 108a and the second root node 106a. The first root node 104 may update an access history table of the first root node 104 according to the received interest packet. The first root node 104 may execute a lower two-tier LPOP. The lower two-tier LPOP may include a parameter based on the popularity of each content of the ICN 100 at each node in the ICN 100.

Where the first tier of the lower two-tier LPOP includes, e.g., the super parent 116a, and the second tier of the lower two-tier LPOP includes the edge nodes 110a-110d, the parameters of the lower two-tier LPOP may also include a cost to obtain the content from the server 102, a cost to obtain the content from the super parent 116a, and a cost to obtain the content from any of the edge nodes 110a-110f. The lower two-tier LPOP may further include a total storage constraint value, indicating the storage limit for the edge nodes 110a-110f and the super parent 116a combined. The solution to the lower two-tier LPOP may include storage size allocation for the edge nodes 110a-110f, which are located on the outer edge of the super parent 116a, and a probability at which to set a cache flag in a data packet of the content to indicate to the edge nodes 110a-110f to store the content, as well as a storage size allocation for the super parent 116a. Any content placement solution for the super parent 116a obtained from the lower two-tier LPOP may be ignored.

The first root node 104 may execute an upper two-tier LPOP. The upper two-tier LPOP may include a parameter based on a popularity of each content of the ICN 100 at each node in the ICN 100. Alternatively, the upper two-tier LPOP may include a parameter based on a popularity of each requested content listed in a content catalog. The content catalog may be updated to eliminate contents determined to be stored according to a solution of a previous lower two-tier LPOP to avoid replicating the content within the ICN 100.

The upper two-tier LPOP may further include a total storage constraint value. Where the first tier of the upper two-tier LPOP includes, e.g., the super parent 116b, and the second tier of the upper two-tier LPOP includes the third level nodes of the ICN 100, including the third root nodes 108a-108b, the total storage constraint value may indicate the combined storage limit for the super parent 116b and the third root nodes. The storage allocation for the super parent 116a obtained from the lower two-tier LPOP may be passed into the upper two-tier LPOP as the total storage constraint value. The parameters for the upper two-tier LPOP may include a cost to obtain the content from the super parent 116b, a cost to obtain the content from the server 102, and a cost to obtain the content from downstream and outside the super parent 116b, which may include costs to obtain the content from the third root nodes 108a-108b and the edge nodes 110a-110f. The cost to obtain the content from the server 102 and the cost to obtain the content from the third root nodes 108a-108b and the edge nodes 110a-110f may be passed into the upper two-tier LPOP from the lower-level two-tier LPOP.

The solution to the upper two-tier LPOP may include storage size allocation for the third root nodes 108a-108b, located on the outer edge of the super parent 116b, and a probability at which to set a cache flag in a data packet of the content to indicate to the third root nodes 108a-108b to store the content. The solution to the upper two-tier LPOP may also include storage size allocation for the super parent 116b. Any content placement solution for the super leaf 116b obtained from the upper two-tier LPOP may be ignored.

When the upper two-tier LPOP includes a super parent 116, where the super parent 116 includes two or more levels, the upper two-tier LPOP may become a lower two-tier LPOP, passing a total storage constraint value and one or more cost values into another upper two-tier LPOP. The first node 104 may decompose the optimization problem in the ICN 100 into two-tier LPOs with increasingly smaller super parents 116 by moving a second tier of a two-tier LPO to a higher level of the ICN 100 than a second tier of a previously executed two-tier LPO. A storage value and one or more cost values obtained from the previously executed two-tier LPO may be passed into an upper two-tier LPO with a smaller super parent 116.

The first tier of a two-tier LPOP may include only a first root node 104 instead of a super parent with two or more levels. In response to the first tier of the two-tier LPOP including only the first root node 104, the first root node 104 may solve the two-tier LPOP to obtain storage size allocation for the first root node 104 and the second root nodes 106a-106b, as well as probabilities at which to set a cache flag in a data packet of the content to indicate to the first root node 104 and the second root nodes 106a-106b to store the content.

Using both the top-down and bottom-up algorithms, contents requested in a network may be placed in-network and storage size may be allocated to provide more cost-efficient delivery of the contents to request nodes in the network.

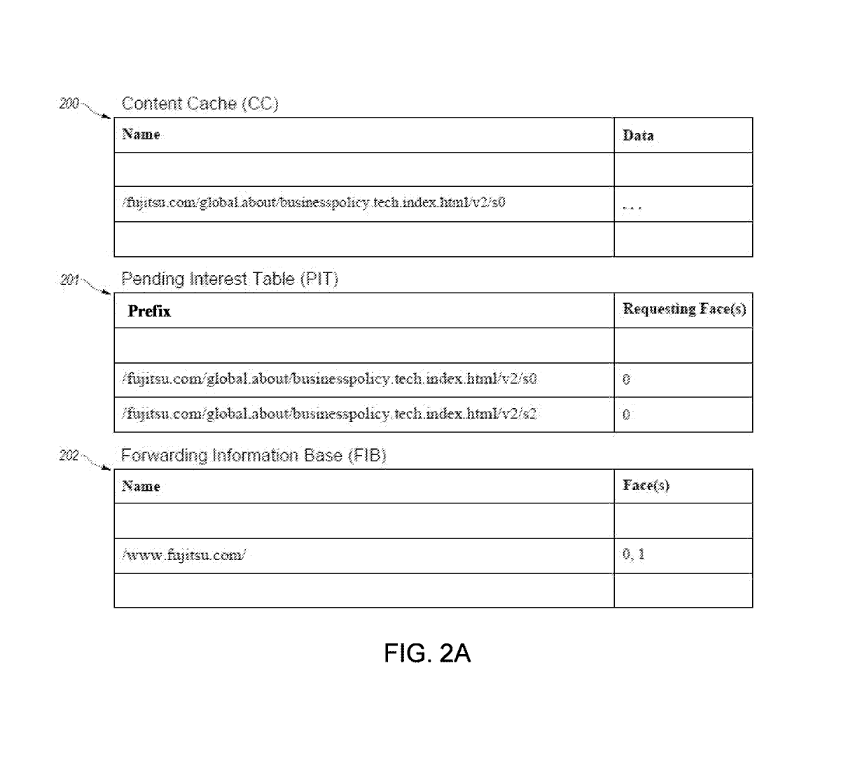

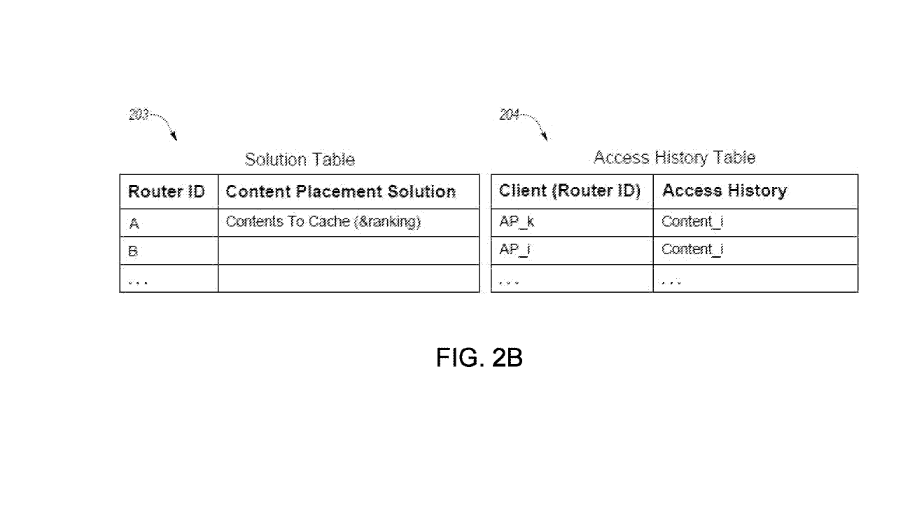

To implement the foregoing, each of the nodes of the ICN 100 may include a router with a pending interest table (PIT), a forwarding information base (FIB), and a content cache (CC) to perform forwarding, delivery, and storage tasks, including recording of interest packets. FIG. 2A is a schematic diagram of three example data structures of a typical ICN router, arranged in accordance with at least one implementation described herein. The three data structures include a CC 200, a PIT 201, and a FIB 202.

The CC 200 may associate interest packets with corresponding data packets. For example, the CC 200 may include a “Name” column that indicates each received interest packet and a “Data” column that indicates the corresponding data packet, which may have been received and cached at the router.

The PIT 201 may record and keep track of each received interest packet that is being served or pending (until the corresponding requested data packet is received) by associating each interest packet with one or more requesting interfaces. The requesting interfaces may be coupled to, for example, one or more of the request nodes 110, third root nodes 108, and/or second root nodes 106, via fixed (wired) links, wireless links, networks, Internet, and/or other components or systems. For example, the PIT 201 may include a “Prefix” column that indicates each interest packet and a “Requesting Face(s)” column that indicates one or more requesting interfaces, e.g. “Requesting Face 0” in FIG. 2A, for the interest packet.

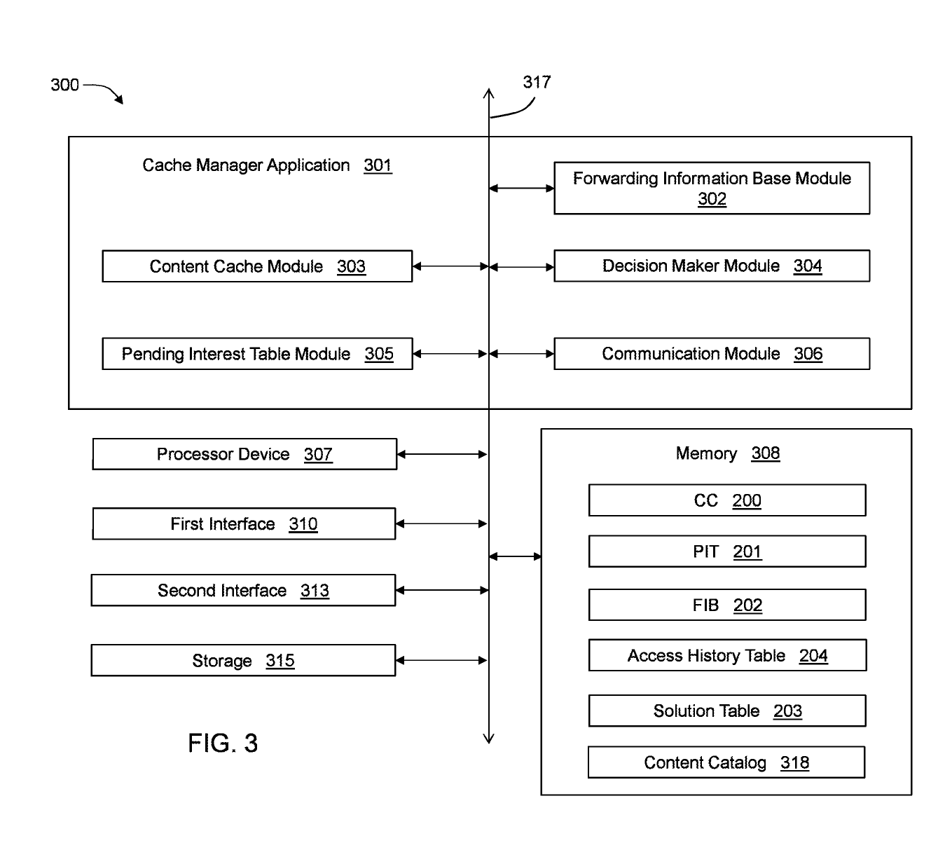

The FIB 202 may associate each interest packet with corresponding forwarding interfaces on which the interest packet may be forwarded. The forwarding interfaces may be coupled to, for example, one or more of the third root nodes 108, second root nodes 106, and/or first root nodes 104 via fixed (wired) links, wireless links, networks, Internet, and/or other components or systems. For example, the FIB 202 may include a “Name” column that indicates each interest packet and a “Face(s)” column that indicates the corresponding forwarding interfaces. A requesting interface may be referred to herein as a “first interface,” and a forwarding interface may be referred to herein as a “second interface.” The CC 200, the PIT 201, and the FIB 202 are explained in more detail with respect to FIG. 3.

In addition to the CC 200, the PIT 201, and the FIB 202, each of the first, second, and third root nodes 104, 106, 108 of the ICN 100 may include a router with an access history table, a solution table, and a content catalog. The access history table may be used to keep track of how many times a content has been accessed by one or more nodes in the ICN 100. The solution table may contain the content placement solution obtained from executing a linear program optimization and may be used to keep track of where content is stored in the ICN 100. FIG. 2B is a schematic diagram of an example solution table 203 and access history table 204 at the first root node 104 of FIGS. 1A-1C, arranged in accordance with at least one implementation described herein. The name of one or more routers in the ICN 100 may be entered in a row of the solution table 203 under the “Router ID” column. A list of contents to be cached at each of the routers, obtained from the linear program optimization, may be entered in the same row of the solution table 203 under the “Content Placement Solution” column. The solution table 203 may contain a Router ID for each of the routers in the ICN 100. The access history table 204 may include a “Client (Router ID)” column that indicates the names of one or more routers in the ICN 100 and an “Access History” column that indicates contents each of the one or mode routers has requested.

A root node in the ICN 100 other than the first root node 104 may include the access history table 204 and solution table 203 when a top-down, decentralized algorithm is used. The access history table may be used to keep track of how many times each content of the network has been accessed at each node downstream from the root node. The solution table may contain the content placement solution obtained from executing a linear program optimization and may be used to keep track of where content is stored in the nodes downstream from the root node.

With combined reference to FIGS. 1 and 2A, in these and other implementations, if a node downstream from the first root node 104 receives an interest packet from the request node 110, but the corresponding data packet is absent from the CC 200 of the node, the next node on a path from the request node 110 to the first root node 104 may check its CC 200. If the data packet is not present in the CC 200 of any node on the path from the request node 110, the first root node 104 may check its CC 200 before forwarding the interest packet towards the server 102. The process of searching for data on the path from the request node 110 to the first root node 104 and returning the data packet from the first node that has the data packet in its CC 200 may be referred to as “path search.” The top-down and bottom-up algorithms are compatible with path search.

FIG. 3 is a block diagram illustrating an example ICN router system (hereinafter “system 300”), arranged in accordance with at least one implementation described herein. The system 300 may be arranged for content placement along the delivery path of a network of nodes and may be implemented as a computing device or system.

The system 300 may include or correspond to any one of the request nodes 110, third root nodes 108, second root nodes 106, and/or first root nodes 104 of FIG. 1. For example, one or more of the request nodes 110, third root nodes 108, second root nodes 106, and/or first root nodes 104 may be implemented as the system 300. The system 300 may be implemented as a router or routing device or other device capable of routing as described herein.

The system 300 may include a cache manager application 301, a processor device 307, a first interface 310, a second interface 313, a storage 315, and a memory 308 according to some examples. The components of the system 300 may be communicatively coupled by a bus 317. The bus 317 may include, but is not limited to, a memory bus, a storage interface bus, a bus/interface controller, an interface bus, or the like or any combination thereof.

The processor device 307 includes an arithmetic logic unit, a microprocessor, a general-purpose controller, or some other processor array to perform or control performance of operations as described herein. The processor device 307 processes data signals and may include various computing architectures including a complex instruction set computer (CISC) architecture, a reduced instruction set computer (RISC) architecture, or an architecture implementing a combination of instruction sets. Although FIG. 3 includes a single processor device 307, multiple processor devices may be included. Other processors, operating systems, and physical configurations may be possible.

The memory 308 stores instructions and/or data that may be executed and/or operated on by the processor device 307. The instructions or data may include programming code that may be executed by the processor device 307 to perform or control performance of the operations described herein. The instructions or data may include the CC 200, the PIT 201, and/or the FIB 202 of FIG. 2A and/or the access history table 204 and/or the solution table 203 of FIG. 2B and/or a content catalog 318. The instructions or data may include the access history table 204 and/or the solution table 203 when the system 300 includes a first root node 104 of FIG. 1 or when the system 300 includes another root node used in the top-down, de-centralized algorithm. The memory 308 may include a dynamic random access memory (DRAM) device, a static random access memory (SRAM) device, flash memory, or some other memory device. In some implementations, the memory 308 also includes a non-volatile memory or similar permanent storage and media including a hard disk drive, a floppy disk drive, a CD-ROM device, a DVD-ROM device, a DVD-RAM device, a DVD-RW device, a flash memory device, or some other mass storage for storing information on a more permanent basis.

The first interface 310 is configured to receive interest packets from and send data packets to at least one request node, third root node, and/or second root node, as explained with respect to FIG. 2A. For example, the first interface 310 may be configured to receive interest packets from and send data packets to the request nodes 110, third root nodes 108, second root nodes 106, and/or first root nodes 104 of FIG. 1.

The second interface 313 is configured to forward interest packets to and receive data packets from at least one third root node, second root node, and/or first root node, as explained with respect to FIG. 2A. For example, the second interface 313 may be configured to forward interest packets to and receive data packets from the third root nodes 108, second root nodes 106, and/or first root nodes 104 of FIG. 1.

In some implementations, the first and second interfaces 310, 313 include a port for direct physical connection to other nodes in the ICN 100 of FIG. 1 or to another communication channel. For example, the first and second interfaces 310, 313 may include a universal serial bus (USB) port, a secure digital (SD) port, a category 5 cable (CAT-5) port, or similar port for wired communication with at least one of the components 102, 104, 106, 108, 110 of FIGS. 1A-1C. In some implementations, the first and second interfaces 310, 313 include a wireless transceiver for exchanging data with at least one of the components 102, 104, 106, 108, 110 of FIGS. 1A-1C or other communication channels using one or more wireless communication methods, including IEEE 802.11, IEEE 802.16, BLUETOOTH®, or another suitable wireless communication method.

In some implementations, the first and second interfaces 310, 313 include a cellular communications transceiver for sending and receiving data over a cellular communications network including via short messaging service (SMS), multimedia messaging service (MMS), hypertext transfer protocol (HTTP), direct data connection, wireless application protocol (WAP), e-mail, or another suitable type of electronic communication. In some implementations, the first and second interfaces 310, 313 may include a wired port and a wireless transceiver. The first and second interfaces 310, 313 may also provide other connections to the ICN 100 or components thereof, for distribution of files or media objects using standard network protocols including transmission control protocol/internet protocol (TCP/IP), HTTP, HTTP secure (HTTPS), and simple mail transfer protocol (SMTP), etc.

The storage 315 may include a non-transitory storage medium that stores instructions and/or data for providing the functionality described herein. The storage 315 may include a dynamic random access memory (DRAM) device, a static random access memory (SRAM) device, flash memory, or some other memory devices. In some implementations, the storage 315 also includes a non-volatile memory or similar permanent storage and media including a hard disk drive, a floppy disk drive, a CD-ROM device, a DVD-ROM device, a DVD-RAM device, a DVD-RW device, a flash memory device, or some other mass storage for storing information on a more permanent basis. The storage 315 may also store instructions and/or data that are temporarily stored or loaded into the memory 308.

As illustrated in FIG. 3, the cache manager application 301 may include at least one of: a content cache module 303 (hereinafter “CC module 303”), a pending interest table module 305 (hereinafter “PIT module 305”), a forwarding information base module 302 (hereinafter “FIB module 302”), a decision maker module 304 (hereinafter “DM Module 304”), and a communication module 306, collectively referred to herein as “modules 309.” The cache manager application 301, including the modules 302-306, may generally include software that includes programming code and/or computer-readable instructions executable by the processor device 307 to perform or control performance of the functions and operations described herein. The cache manager application 301, including one or more of the modules 302-306, may receive data from one or more of the components of the system 300 and/or may store the data in one or both of the storage 315 and the memory 308.

The CC module 303 may generally be configured to associate interest packets with corresponding data packets that may be stored at request nodes and root nodes, such as the request nodes 110, third root nodes 108, second root nodes 106, and/or first root nodes 104 of FIG. 1, as described in more detail herein. In this and other implementations, the CC module 303 may read data from and/or write data to the CC 200.

The PIT module 305 may be configured to record and keep track of each received interest packet that is being served or pending (until the corresponding requested data packet is received) by associating each interest packet with one or more receiving interfaces, as described in more detail herein. In these and other implementations, the PIT module 305 may read data from and/or write data to the PIT 201.

The FIB module 302 may be configured to associate interest packets with one or more corresponding interfaces on which the interest packet is forwarded, as described in more detail herein. The FIB module 312 may read data from and/or write data to the FIB 202.

The DM module 304, which may be present when the system 300 includes a first root node used in the top-down or bottom-up algorithm or another root node used in the top-down, de-centralized algorithm, may be configured to execute one or more LPOPs to determine how to allocate storage size at one or more nodes of the network and/or where to place each of the contents in the network to minimize the total cost of data download in the sub-network. Based on the solutions of the one or more LPOPs, the DM module 404 may be configured to set one or more cache flags in the data packet of a content to inform one or more nodes in the network to cache the content. Further, the DM module 404 may be configured to update the content catalog to eliminate contents determined to be stored according to a solution of a previous optimization.

The communication module 306 may be implemented as software including routines for handling communications between the modules 302-305 and other components of the system 300. The communication module 306 sends and receives data, via the first and second interfaces 310 and 313, to and from one or more of the components 102, 104, 106, 108, 110 of FIGS. 1A-1C when the cache manager application 301 is implemented at the first root node 104 of FIGS. 1A-1C or another root node used in the top-down, de-centralized algorithm. In some implementations, the communication module 306 receives data from one or more of the modules 302-305 and stores the data in one or more of the storage 315 and the memory 308. In some implementations, the communication module 306 retrieves data from the storage 315 or the memory 308 and sends the data to one or more of the modules 302-305.

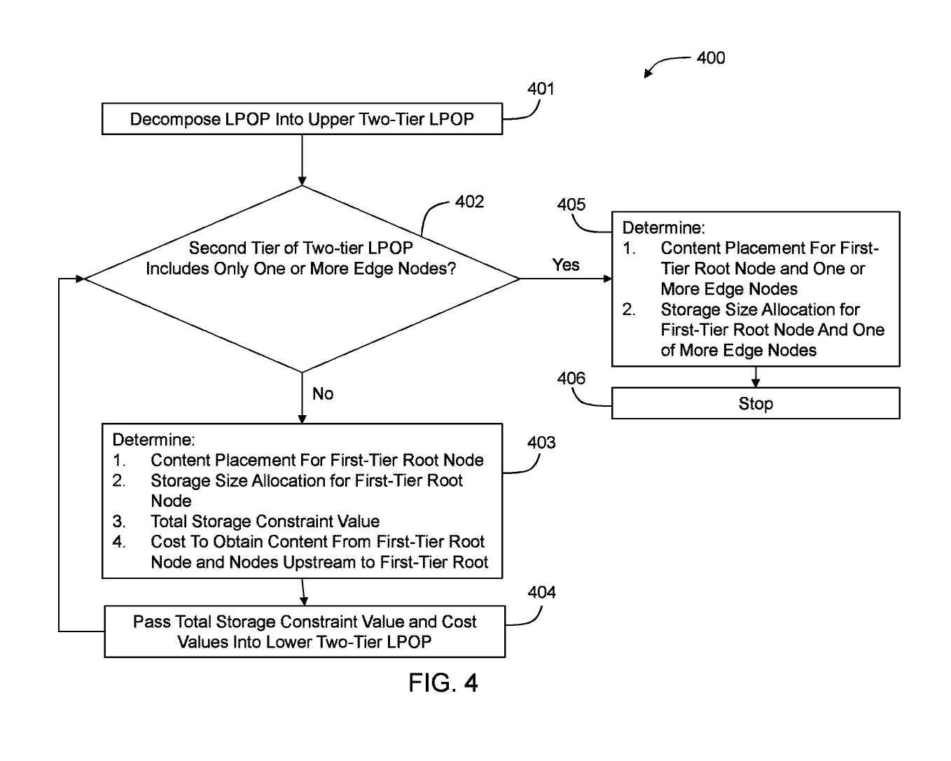

FIG. 4 is an example flow diagram illustrating a content placement and storage allocation method 400 in a top-down algorithm, arranged in accordance with at least one implementation described herein. The method 400 may be implemented, in whole or in part, by one or more first root nodes 104 of FIGS. 1A-1C, or another suitable network node, ICN router, and/or system. In a top-down de-centralized approach, the method 400 may be implemented, in whole or in part, by two or more root nodes of the ICN 100 of FIG. 1. The method 400 may begin at block 401.

In block 401, a root node may decompose a LPOP in a network into an upper two-tier LPOP and one or more lower two-tier LPOPs. The network may include three or more levels. The root node may include another root node used in a top-down, de-centralized algorithm or a first root node in either a top-down or bottom-up algorithm. Block 401 may be followed by block 402.

In block 402, the root node may determine if a second tier of a two-tier LPOP includes only one or more edge nodes. The two-tier LPOP may include the upper two-tier LPOP of block 401 or each of one or more lower two-tier LPOPs referred to with respect to block 404. Block 402 may be followed by block 403 if the second tier of the two-tier LPOP does not include only one or more edge nodes (“No” at block 402). Block 402 may be followed by block 405 if the second tier of the two-tier LPOP includes only one or more edge nodes (“Yes” at block 402).

In block 403, in response to the second tier of the two-tier LPOP not including only edge nodes, the root node may determine content placement and storage size allocation for a first-tier root node of the two-tier LPOP. The root node may also determine a total storage constraint value to pass into each of one or more lower two-tier LPOPs. Further, the root node may determine a cost to obtain a requested content from the first-tier root node and one or more nodes upstream to the first-tier root node. Block 403 may be followed by block 404.

In block 404, the root node may pass the constraint value obtained from the two-tier LPOP and one or more cost values into each of the one or more lower two-tier LPOPs. The cost values may include the cost to obtain the content from the first-tier root node and/or the cost to obtain the content from one or more nodes upstream to the first-tier root node. One of the nodes upstream to the first-tier node may include a server. Block 404 may be followed by blocks 402, 403, 404, 405, and/or 406 for each of the one or more lower two-tier LPOPs.

In block 405, in response to the two-tier LPOP including only one or more edge nodes, the root node may determine content placement for the first-tier root node and the one or more edge nodes. The root node may also determine storage size allocation for the first-tier root node and the one or more edge nodes. Block 405 may be followed by block 406.

In block 406, the root node may stop performing additional LPOPs.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed implementations.

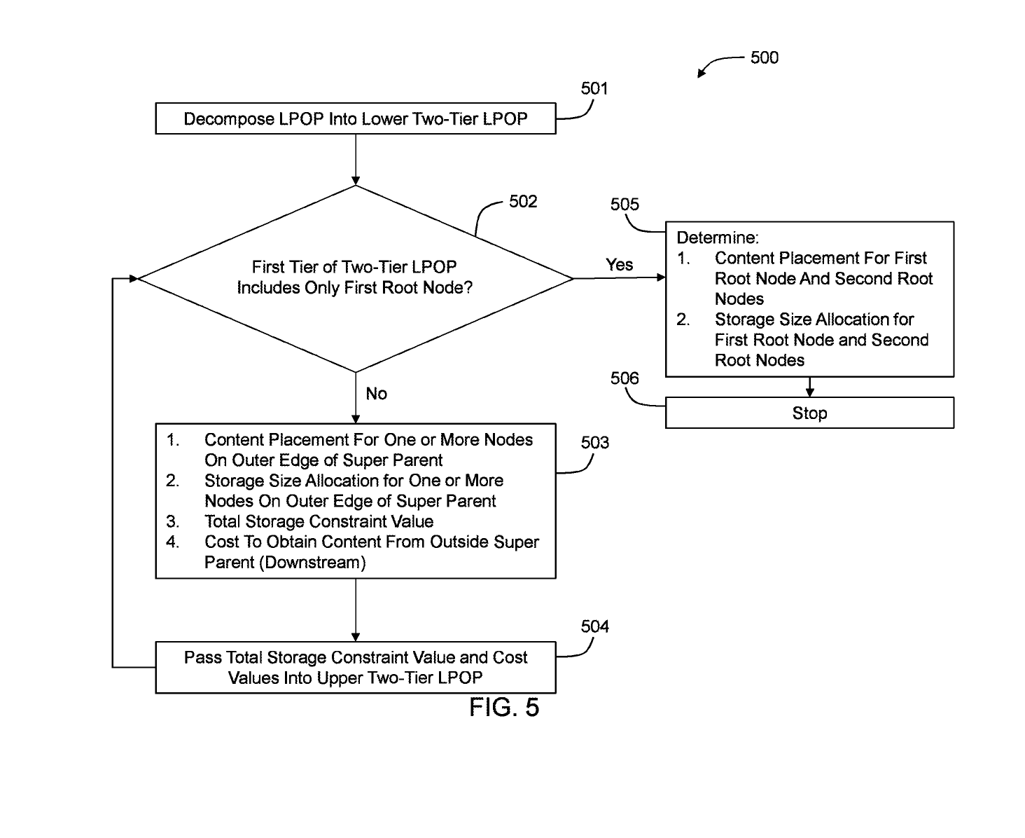

FIG. 5 is an example flow diagram illustrating a content placement and storage allocation method 500 in a bottom-up algorithm, arranged in accordance with at least one implementation described herein. The method 500 may be implemented, in whole or in part, by one or more first root nodes 104 of FIGS. 1A-1C, or another suitable network node, ICN router, and/or system. The method 500 may begin at block 501.

In block 501, a first root node may decompose a LPOP in a network into a lower two-tier LPOP and one or more upper two-tier LPOPs. The network may include three or more levels. Block 501 may be followed by block 502.

In block 502, the first root node may determine if a first tier of a two-tier LPOP includes only the first root node. The two-tier LPOP may include the lower two-tier LPOP of block 501 or each of one or more upper two-tier LPOPs referred to with respect to block 504. Block 502 may be followed by block 503 if the first tier of the two-tier LPOP does not include only the first root node (“No” at block 502). Block 502 may be followed by block 505 if the first tier of the two-tier LPOP includes only the first root node (“Yes” at block 505).

In block 503, in response to the first tier of the two-tier LPOP not including only the first root node, the first root node may determine content placement and storage size allocation for one or more nodes on an outer edge of a super parent. The first root node may also determine a total storage constraint value to pass into each of one or more upper two-tier LPOPs. Further, the first root node may determine a cost to obtain a requested content from downstream and outside the super parent. Block 503 may be followed by block 504.

In block 504, the first root node may pass the constraint value obtained from the two-tier LPOP and one or more cost values into each of the one or more upper two-tier LPOPs. The cost values may include the cost to obtain the content from downstream and outside the super parent, and/or the cost to obtain the content from one or more nodes upstream to the first root node, which may include a server. Block 504 may be followed by block 502, 503, 504, 505, and/or 506 for each of the one or more upper two-tier LPOPs.

In block 505, in response to the first tier of the two-tier LPOP including only the first root node, the first root node may determine content placement and storage size allocation for the first root node and second root nodes. Block 505 may be followed by block 506.

In block 506, the first root node may stop performing additional LPOPs.

Implementations described herein may include computer-readable media for carrying or having computer-executable instructions or data structures stored thereon. Such computer-readable media may be any available media that may be accessed by a general purpose or special purpose computer. By way of example, and not limitation, such computer-readable media may include non-transitory computer-readable storage media including RAM, ROM, EEPROM, CD-ROM or other optical disk storage, magnetic disk storage or other magnetic storage devices, or any other storage medium which may be used to carry or store desired program code in the form of computer-executable instructions or data structures and which may be accessed by a general purpose or special purpose computer. Combinations of the above may also be included within the scope of computer-readable media.

Computer-executable instructions include, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the term “module” or “component” may refer to software objects or routines that execute on the computing system. The different components, modules, engines, and services described herein may be implemented as objects or processes that execute on the computing system (e.g., as separate threads). While the system and methods described herein are preferably implemented in software, implementations in hardware or a combination of software and hardware are also possible and contemplated. In this description, a “computing entity” may be any computing system as previously defined herein, or any module or combination of modulates running on a computing system.

All examples and conditional language recited herein are intended for pedagogical objects to aid the reader in understanding the invention and the concepts contributed by the inventor to furthering the art, and are to be construed as being without limitation to such specifically recited examples and conditions. Although implementations of the present inventions have been described in detail, it should be understood that the various changes, substitutions, and alterations could be made hereto without departing from the spirit and scope of the invention.

1. A method, comprising:
decomposing an optimization problem in a network that includes three or more levels into two or more two-tier optimization problems; and
passing a storage value and one or more cost values obtained from an upper or lower one of the two-tier optimization problems into, respectively, a lower or upper one of the two-tier optimization problems.

2. The method of claim 1, wherein each of the two or more two-tier optimization problems includes a linear program optimization problem.

3. The method of claim 1, wherein the storage value obtained from the upper or lower one of the two-tier optimizations includes a total storage constraint value.

4. The method of claim 1, wherein at least one of the two-tier optimization problems includes a parameter based on a popularity of each content of the network at each node in the network.

5. The method of claim 1, wherein at least one of the two-level optimization problems includes a parameter based on a popularity of each content listed in a content catalog, wherein the content catalog is updated to eliminate contents determined to be stored according to a solution of a previous optimization.

6. The method of claim 1, wherein passing the storage value and the one or more cost values obtained from the upper or lower one of the two-tier optimizations into, respectively, a lower or upper one of the two-tier optimizations, includes forwarding the storage and cost values to a node in the network to allow the node to which the storage and cost values are passed to solve the two-tier optimization.

7. The method of claim 1, further comprising in a top-down algorithm and in response to a second of the tiers of one of the two-tier optimization problems including only one or more edge nodes, solving the one of the two-tier optimization problem to obtain storage size allocation for the one or more edge nodes and a probability at which to set a cache flag in a data packet of a content to indicate to the one or more edge nodes to store the content.

8. The method of claim 1, further comprising in a bottom-up algorithm and in response to a first of the tiers of one of the two-tier optimization problems including only a first root node, solving the one of the two-tier optimization problems to determine storage size allocation for the first root node and a probability at which to set a cache flag in a data packet of a content to indicate to the first root node to store the content.

9. The method of claim 1, wherein the network includes a first and second sub-network and wherein decomposing the optimization problem in the network into two or more two-tier optimization problems is performed according to a top-down algorithm in the first sub-network and according to a bottom-up algorithm in the second sub-network, the method further comprising determining whether to use the top-down algorithm or the bottom-up algorithm in each of the sub-networks based on a similarity of a demand statistic at each of the nodes on a level of the corresponding sub-network.

10. A system, comprising:
a plurality of nodes of a network that includes three or more levels, wherein a first root node is configured to:
decompose a linear program optimization problem in the network into two or more two-tier linear program optimization problems; and
pass a total storage constraint value and one or more cost values obtained from an upper or lower one of the two-tier linear program optimization problems into, respectively, a lower or upper one of the two-tier linear program optimization problems.

11. The system of claim 10, wherein at least one of the two-tier linear program optimization problems includes a parameter based on a popularity of each content of the network at each node in the network.

12. The system of claim 10, wherein at least one of the two-tier linear program optimization problems includes a parameter based on a popularity of each content listed in a content catalog, wherein the content catalog is updated to eliminate contents determined to be stored according to a solution of a previous linear program optimization.

13. The system of claim 10, wherein the first root node is configured to pass the total storage constraint value and the one or more cost values obtained from the upper or lower one of the two-tier linear program optimizations into, respectively, a lower or upper one of the two-tier linear program optimizations by being configured to forward the storage and cost values to a node in the network to allow the node to which the storage and cost values are passed to solve the two-tier linear program optimization.

14. The system of claim 10, wherein in a top-down algorithm and in response to a second of the tiers of one of the two-tier linear program optimization problems including only one or more edge nodes, the first root node is further configured to solve the one of the two-tier linear program optimization problem to obtain storage size allocation for the one or more edge nodes and a probability at which to set a cache flag in a data packet of a content to indicate to the one or more edge nodes to store the content.

15. The system of claim 10, wherein in a bottom-up algorithm and in response to a first of the tiers of one of the two-tier linear optimization problems including only the first root node, the first root node is further configured to solve the one of the two-tier optimization problems to determine storage size allocation for the first root node and a probability at which to set a cache flag in a data packet of a content to indicate to the first root node to store the content.

16. The system of claim 10, wherein the first node is further configured to:
decompose the linear program optimization problem in the network into two or more two-tier linear program optimization problems by being configured to perform the decomposition according to a top-down algorithm in a first sub-network and according to a bottom-up algorithm in the second sub-network; and
determine whether to use the top-down algorithm or the bottom-up algorithm in each of the sub-networks based on a similarity of a demand statistic at each of the nodes on a level of the corresponding sub-network.

17. A non-transitory computer-readable medium that includes computer-readable instructions stored thereon that are executable by a processor to perform or control performance of operations comprising:
decomposing a linear program optimization problem in a network that includes three or more levels into two or more two-tier linear program optimization problems, wherein at least one of the two-tier linear program optimization problems includes a parameter based on a popularity of each content of the network at each node in the network; and
passing a total storage constraint value and one or more cost values obtained from an upper or lower one of the two-tier linear program optimization problems into, respectively, a lower or upper one of the two-tier linear program optimization problems.

18. The non-transitory computer-readable medium of claim 17, wherein at least one of the two-tier linear program optimization problems includes a parameter based on a popularity of each content listed in a content catalog, wherein the content catalog is updated to eliminate contents determined to be stored according to a solution of a previous linear program optimization.

19. The non-transitory computer-readable medium of claim 17, wherein passing the total storage constraint value and the one or more cost values obtained from the upper or lower one of the two-tier linear program optimizations into, respectively, a lower or upper one of the two-tier linear program optimizations comprises forwarding the storage and cost values to a node in the network to allow the node to which the storage and cost values are passed to solve the two-tier linear program optimization.

20. The non-transitory computer-readable medium of claim 17, wherein the operations further comprise in a top-down algorithm and in response to a second of the tiers of one of the two-tier linear program optimization problems including only one or more edge nodes, solving the two-tier linear program optimization problem to obtain storage size allocation for the request node and a probability at which to set a cache flag in a data packet of a content to indicate to the one or more edge nodes to store the content.

21. The non-transitory computer-readable medium of claim 17, wherein the operations further comprise in a bottom-up algorithm and in response to a first of the tiers of one of the two-tier linear program optimization problems including only a first root node, solving the one of the two-tier optimization problems to determine storage size allocation for the first root node and a probability at which to set a cache flag in a data packet of a content to indicate to the first root node to store the content.

22. The non-transitory computer-readable medium of claim 17, wherein the operations further comprise:
decomposing the linear program optimization problem in the network into two or more two-tier linear program optimization problems according to a top-down algorithm in a first sub-network and according to a bottom-up algorithm in the second sub-network; and
determining whether to use the top-down algorithm or the bottom-up algorithm in each of the sub-networks based on a similarity of a demand statistic at each of the nodes on a level of the corresponding sub-network.
